(19) United States
(12) Patent Application Publication
(10) Pub. No.: US 2019/0091852 A1
(43) Pub. Date: Mar. 28, 2019

(54) ROBOT AND ROBOT SYSTEM

(71) Applicant: Seiko Epson Corporation, Tokyo (JP)

(72) Inventors: Takema YAMAZAKI, Fujimi (JP); Yuki SAGAWA, Azumino (JP); Koki YAMAGUCHI, Azumino (JP)

(21) Appl. No.: 16/142,059

(22) Filed: Sep. 26, 2018

(30) Foreign Application Priority Data
Sep. 28, 2017 (JP) 2017-189064

(51) Int. Cl. B25J 9/00; B25J 9/16

(52) U.S. Cl. CPC B25J 9/0009; B25J 9/1664

(57) ABSTRACT

A robot controlled by a robot control apparatus comprising a base having conductivity; an arm provided on the base; an actuator that drives the arm; a connector connected to the robot control apparatus by a first wire having a power line; and a second wire that connects the actuator and the connector, wherein the base has a housing part having an opening portion, to which the connector is fixed, and a lid part covering at least a part of the opening portion, through which the first wire is inserted, the first wire has a shield in contact with the lid part, and the shield is in contact with a part having conductivity of the robot control apparatus.

### BACKGROUND

### 1. Technical Field

The present invention relates to a robot and a robot system.

### 2. Related Art

Research and development of respective technologies on robots and robot control apparatuses that control robots are carried out.

In this regard, an industrial robot connected to a separate robot control apparatus by a wire (wired connection) and controlled by the robot control apparatus is known (see Patent Document 1 (JP-A-2016-78221)).

In the industrial robot, a connecting portion (e.g. connector) to which the wire connecting between the industrial robot and the robot control apparatus is connected is provided outside of the base of the industrial robot. In the connecting portion provided outside of the base, a defect of deformation by application of an unintended impact or the like may be caused. On the other hand, when the connecting portion is provided inside of the base of the industrial robot, the connecting portion floats in the air inside of the base, and a defect of breaking of the wire connected to the connecting portion may be caused. Further, when the connecting portion is provided inside of the base of the industrial robot, in the industrial robot, impedance of the frame ground between the industrial robot and the robot control apparatus may be higher, the shield effect may be insufficient and electromagnetic wave may be radiated, and communications etc. of other apparatuses of the industrial robot may be hindered.

### SUMMARY

An aspect of the invention is directed to a robot controlled by a robot control apparatus and including a base having conductivity, a movable unit provided on the base, a drive unit that drives the movable unit, a connecting portion connected to the robot control apparatus by a first wire having a power line, and a second wire that connects the drive unit and the connecting portion, and the base has a housing part having an opening portion, to which the connecting portion is fixed, and a lid part covering at least a part of the opening portion, through which the first wire is inserted, in which the first wire has a shield in contact with the lid part, and the shield is in contact with a part having conductivity of the robot control apparatus.

With this configuration, in the robot, a defect in at least one of the connecting portion and the second wire may be suppressed and noise due to electromagnetic wave radiated from the first wire may be suppressed.

In another aspect of the invention, the robot may be configured such that a potential of the lid part is equal to a potential of the base.

With this configuration, in the robot, the noise due to electromagnetic wave radiated from the first wire may be suppressed more reliably by the lid part having the equal potential to the potential of the base.

In another aspect of the invention, the robot may be configured such that a voltage by switching control is applied to the first wire.

With this configuration, in the robot, the noise due to electromagnetic wave radiated from the first wire to which the voltage by switching control is applied may be suppressed.

In another aspect of the invention, the robot may be configured such that the lid part and the base are in contact with each other.

With this configuration, in the robot, the noise due to electromagnetic wave radiated from the first wire may be suppressed more reliably by the lid part in contact with the base.

In another aspect of the invention, the robot may be configured such that the lid part and the base are in surface contact with each other.

With this configuration, in the robot, the noise due to electromagnetic wave radiated from the first wire may be suppressed more reliably by the lid part in surface contact with the base.

In another aspect of the invention, the robot may be configured such that the connecting portion has a first connection portion to which the first wire is connected and a second connecting portion to which a third wire having a signal line is connected.

With this configuration, in the robot, the noise due to electromagnetic wave radiated from the first wire connected to the first connecting portion may be suppressed.

In another aspect of the invention, the robot may be configured such that the third wire has a shield and has a portion surrounded by a magnetic material in a circumferential direction.

With this configuration, in the robot, the noise due to electromagnetic wave radiated from the first wire connected to the first connecting portion may be suppressed, and the noise due to electromagnetic wave radiated from the third wire connected to the second connecting portion may be suppressed.

In another aspect of the invention, the robot may be configured such that the first wire has a portion surrounded by a magnetic material in a circumferential direction.

With this configuration, in the robot, the noise due to electromagnetic wave radiated from the first wire may be suppressed more reliably by the magnetic material.

In another aspect of the invention, the robot may be configured such that a resin is provided between the first wire and the lid part.

With this configuration, in the robot, entry of foreign matter from between the first wire and the lid part into the housing part may be suppressed.

In another aspect of the invention, the robot may be configured such that the housing part has no conductivity.

With this configuration, in the robot, the noise due to electromagnetic wave radiated from the first wire may be suppressed by the lid part covering the opening portion of the housing part without conductivity.

In another aspect of the invention, the robot may be configured such that the housing part has conductivity.

With this configuration, in the robot, the noise due to electromagnetic wave radiated from the first wire may be suppressed by the lid part covering the opening portion of the housing part with conductivity.

In another aspect of the invention, the robot may be configured such that the second wire has a shield in contact with the housing part.

With this configuration, in the robot, the noise due to electromagnetic wave radiated from the first wire may be suppressed, and the noise due to electromagnetic wave radiated from the second wire may be suppressed.

In another aspect of the invention, the robot may be configured such that the robot further includes a fourth wire that connects the drive unit and the connecting portion, and the fourth wire has a shield in contact with the housing part.

With this configuration, in the robot, the noise due to electromagnetic wave radiated from the first wire may be suppressed, and the noise due to electromagnetic wave radiated from the fourth wire may be suppressed.

Another aspect of the invention is directed to a robot system including the robot described above and the robot control apparatus.

With this configuration, in the robot system, a defect in at least one of the connecting portion and the second wire may be suppressed and noise due to electromagnetic wave radiated from the first wire may be suppressed.

### BRIEF DESCRIPTION OF THE DRAWINGS

The invention will be described with reference to the accompanying drawings, wherein like numbers reference like elements.

FIG. 1 shows an example of a configuration of a robot system according to an embodiment.

FIG. 2 shows an example of a base as seen toward a positive direction of an X-axis in a robot coordinate system.

FIG. 3 shows an example of the base as seen toward a positive direction of a Y-axis in the robot coordinate system.

FIG. 4 shows an example of a lid part through which a first wire is inserted.

FIG. 5 shows an example of a connection state of the first wire, a second wire, a third wire, and a fourth wire via respective connecting portions toward a negative direction of a Z-axis in the robot coordinate system.

FIG. 6 shows another example of the connection state of the first wire, the second wire, the third wire, and the fourth wire via the respective connecting portions toward the negative direction of the Z-axis in the robot coordinate system.

FIG. 7 shows graphs for comparison of noise due to electromagnetic wave radiated from the first wire in the respective cases with and without measures against noise described in FIG. 5.

FIG. 8 shows graphs for comparison of magnitude of conducted emission in the respective cases with or without measures against noise described in FIG. 5.

### DESCRIPTION OF EXEMPLARY EMBODIMENTS

### Embodiment

As below, an embodiment of the invention will be explained with reference to the drawings.

### Outline of Robot

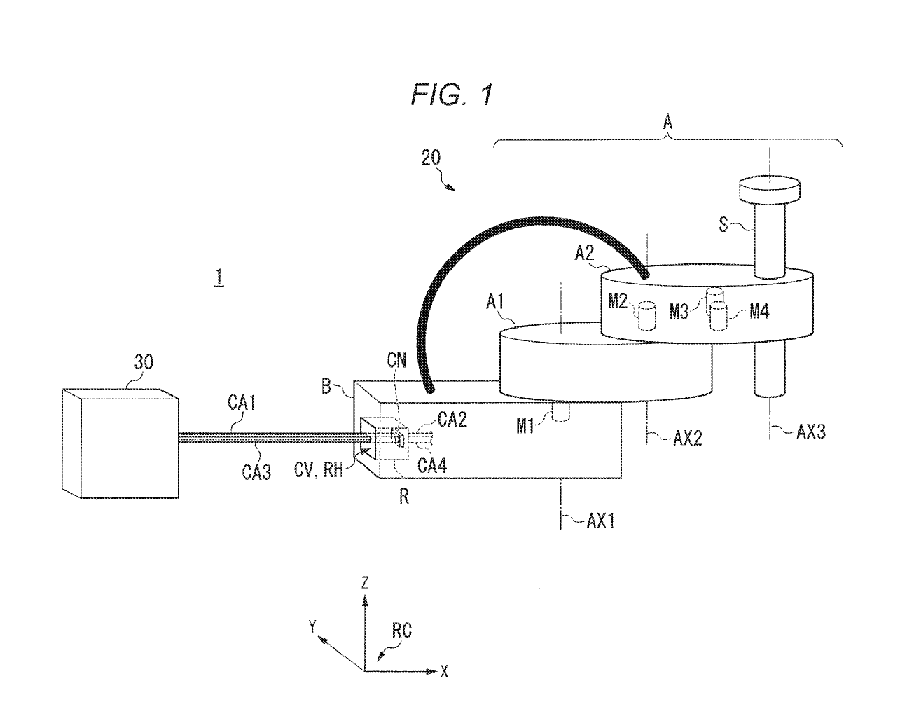

FIG. 1 shows an example of a configuration of a robot system 1 according to the embodiment.

First, the outline of a robot 20 of the robot system 1 according to the embodiment will be explained.

The robot 20 is a robot controlled by a robot control apparatus. The robot 20 includes a base having conductivity, a movable unit provided on the base, a drive unit that drives the movable unit, a connecting portion connected to the robot control apparatus by a first wire having a power line, and a second wire that connects the drive unit and the connecting portion. The base has a housing part having an opening portion, to which the connecting portion is fixed, and a lid part covering at least a part of the opening portion, through which the first wire is inserted. The first wire has a shield in contact with the lid part. Further, the shield is in contact with apart having conductivity of the robot control apparatus. According to these configurations, in the robot 20, a defect in at least one of the connecting portion and the second wire may be suppressed and noise due to electromagnetic wave radiated from the first wire (i.e., radiated emission) may be suppressed. As below, a specific example of the configuration of the robot system 1 including the above described configurations of the robot 20 will be explained in detail.

### Configuration of Robot System

As below, the configuration of the robot system 1 will be explained.

As shown in FIG. 1, the robot system 1 includes the robot 20 and a robot control apparatus 30 as an example of the above described robot control apparatus.

The robot 20 is a horizontal articulated robot (scalar robot). Note that the robot 20 may be another robot such as a Cartesian coordinate robot or vertical articulated robot (e.g. single-arm robot, dual-arm robot, or the like) in place of the horizontal articulated robot. The Cartesian coordinate robot is e.g. a gantry robot.

In the example shown in FIG. 1, the robot 20 is installed on an installation surface as a predetermined surface. The installation surface is e.g. a floor surface of a room in which the robot 20 is installed. Note that the installation surface may be a wall surface within the room, a ceiling surface within the room, an upper surface of a table, an upper surface of a jig, an upper surface of a bench, or an outdoor floor surface or an outdoor wall surface, or another surface in place of the floor surface. Hereinafter, for convenience of explanation, a direction orthogonal to the installation surface from the center of gravity of the robot 20 toward the installation surface is referred to as “lower” or “downward direction” and a direction opposite to the direction is referred to as “upper” or “upward direction”. Further, as below, as an example, the case where the downward direction coincides with both a negative direction of a Z-axis in a robot coordinate system RC as a robot coordinate system of the robot 20 and the direction of gravity will be explained. Note that the downward direction may not necessarily coincide with one or both of the negative direction and the gravity direction instead.

The robot 20 includes a base B as an example of the above described base, and a movable unit A as an example of the above described movable unit.

The base B is installed (fixed) unmovably on the installation surface.

The movable unit A includes a first arm A1, a second arm A2, and a shaft S.

The first arm A1 is rotatably supported by the base B about a first axis AX1.

The second arm A2 is rotatably supported by the first arm A1 about a second axis AX2.

The shaft S is rotatably supported about a third axis AX3 and translationally supported in the axis direction of the third axis AX3 by the second arm A2.

The shaft S is an axial member having a cylindrical shape. A ball screw groove and a spline groove (not shown) are respectively formed in the circumferential surface of the shaft S. The shaft S is provided to penetrate an opposite end portion to the first arm A1 of the end portions of the second arm A2 in the upward and downward directions. Further, in the shaft S, in the example, a flange in a circular disc shape having a larger radius than the radius of the cylinder is provided in the upper end portion of the end portions of the shaft S. The center axis of the cylinder coincides with the center axis of the flange. It may be possible or impossible to attach an end effector to the distal end as the end portion of the shaft S in which the flange is not provided. Further, the cylinder and the flange may be integrally or separately formed.

The base B has conductivity. In the example shown in FIG. 1, the shape of the base B is a rectangular parallelepiped shape. Hereinafter, for convenience of explanation, the surface in contact with the installation surface of the six surfaces of the base B is referred to as the lower surface of base B. Further, in the example, the direction along the longitudinal direction of the base B of the directions parallel to the installation surface coincides with the direction along an X-axis in the robot coordinate system RC. Furthermore, in the example, the direction along the lateral direction of the base B of the directions parallel to the installation surface coincides with the direction along a Y-axis in the robot coordinate system RC. Here, the positive direction of the Z-axis in the robot coordinate system RC coincides with a direction of a vector obtained by an outer product of multiplication from the right of a vector toward the positive direction of the X-axis by a vector toward the positive direction of the Y-axis. Note that the direction along the X-axis does not necessarily coincide with the direction along the longitudinal direction. That is, the direction along the Y-axis does not necessarily coincide with the direction along the lateral direction. Hereinafter, for convenience of explanation, the surface orthogonal to the lower surface of the base B of the six surfaces of the base B on the negative direction side of the X-axis in the robot coordinate system RC is referred to as “back surface” of the base B.

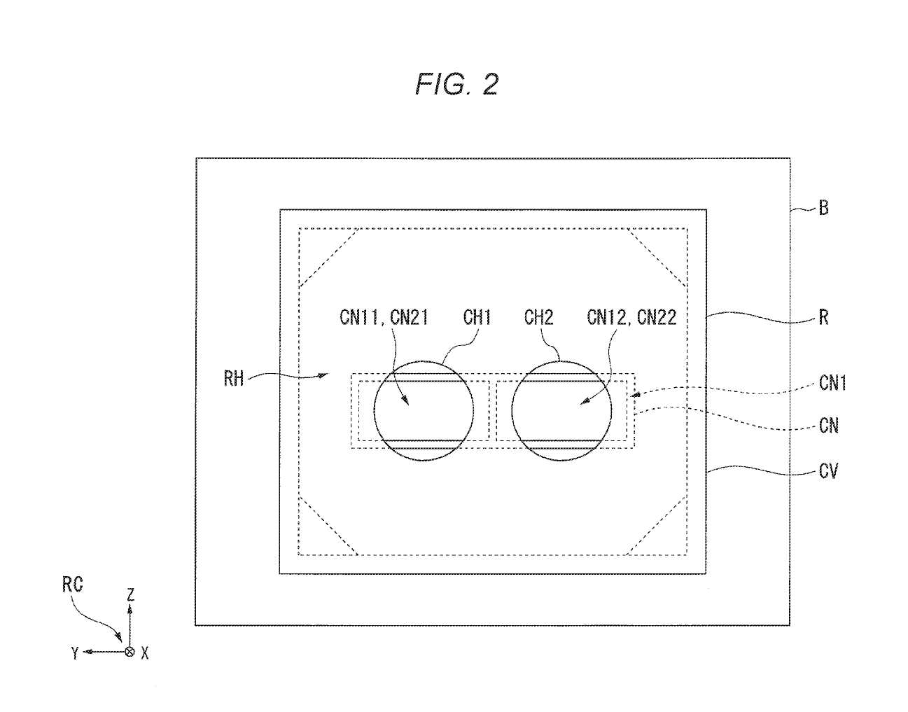

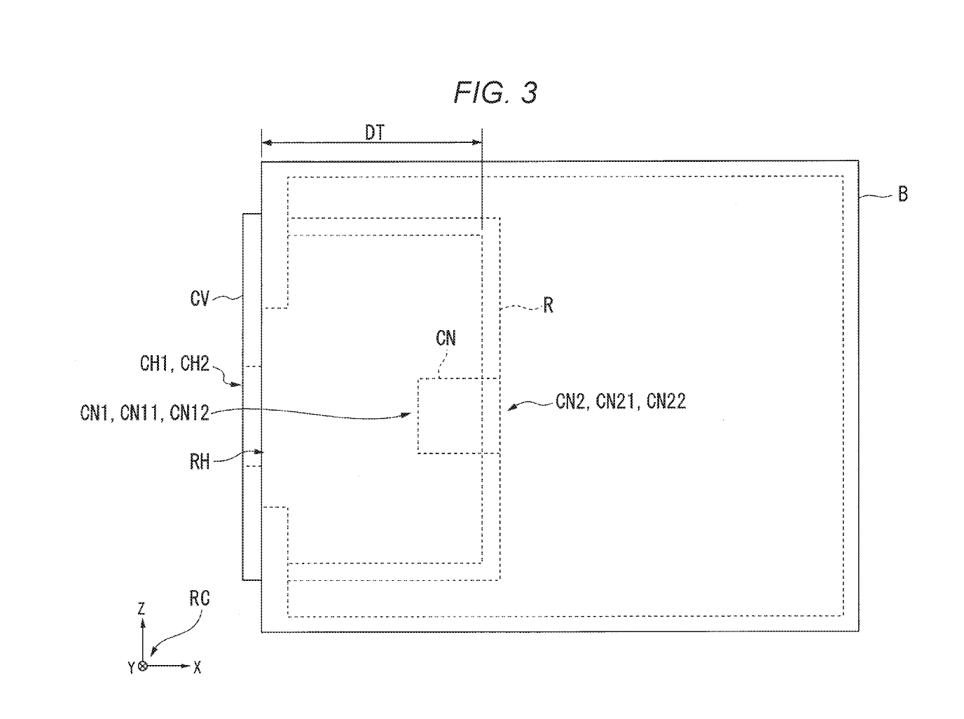

The base B has a housing part R. Here, referring to FIGS. 2 and 3, the housing part R is explained. FIG. 2 shows an example of the base B as seen toward the positive direction of the X-axis in the robot coordinate system RC. FIG. 3 shows an example of the base B as seen toward the positive direction of the Y-axis in the robot coordinate system RC.

In the example, the housing part R is provided on the back surface of the base B so that the whole housing part R may be located (contained) inside of the base B. Note that the housing part R may be provided on another surface than the back surface of the six surfaces of the base B so that the whole housing part R may be located inside of the base B. Or, part or entire of the housing part R is not necessarily contained inside of the base B. In this case, at least a part of the housing part R is provided outside of the base B. In the case, for example, at least a part of the housing part R is provided on the back surface of the base B to be located outside of the base B.

The housing part R is a member that can fix some object inside of the housing part R in e.g. a container shape. However, the part may have a frame shape instead or any shape that can fix the object inside of the housing part R.

In the example, the housing part R is a container having a rectangular parallelepiped shape. Note that the shape of the housing part R may be another shape in place of the rectangular parallelepiped shape. Here, the housing part R may be formed by a single member or a plurality of members. In the example, one surface of the six surfaces of the housing part R is formed by the back surface of the base B. Note that a part or all of the six surfaces of the housing part R may be formed by at least a part of one or more surfaces of the base B or may not.

An opening portion RH as a hole connecting outside and inside of the housing part R is formed in the back surface of the base B (i.e., the surface on the negative direction side of the X-axis in the robot coordinate system RC of the surfaces of the housing part R). The shape of the opening portion RH when the base B is seen toward the positive direction of the X-axis in the robot coordinate system RC is nearly a rectangular shape with the respective triangles on the four corners cut off in the rectangular shape. Note that the shape of the opening portion RH in the case may be another shape such as a circular shape.

Here, a connecting portion CN is fixed inside of the housing part R.

The connecting portion CN is a connector having a first part CN1 and a second part CN2.

The first part CN1 refers to a part to which wires connecting the robot control apparatus 30 and the connecting portion CN are connected of the parts of the connecting portion CN. The wires include a first wire CA1 (for example, see FIG. 1) and a third wire CA3 (for example, see FIG. 1). The first wire CA1 is a wire having a power line for supplying electric power from the robot control apparatus 30 to a drive unit (e.g. an actuator, which will be described later) of the robot 20 (more specifically, the movable unit A). The third wire CA3 is a wire having a signal line for transmitting signals between the robot control apparatus 30 and the drive unit. The signals are control signals for the robot control apparatus 30 to control the robot 20 etc. Note that the first wire CA1 may include another wire in addition to the power line. Further, the third wire CA3 may include another wire in addition to the signal line. Note that, in FIGS. 2 and 3, the first wire CA1 and the third wire CA3 are omitted to avoid complication of the drawings.

In the first part CN1, a connecting portion CN11 and a connecting portion CN12 are provided. The connecting portion CN11 refers to a connector to which the first wire CA1 is connected. The connecting portion CN11 is an example of a first connecting portion. The connecting portion CN12 refers to a connector to which the third wire CA3 is connected. The connecting portion CN12 is an example of a second connecting portion.

The second part CN2 refers to a part to which wires connecting a drive unit (e.g. an actuator, which will be described later) of the robot 20 (more specifically, the movable unit A) and the connecting portion CN are connected of the parts of the connecting portion CN. The wires include a second wire CA2 and a fourth wire CA4. The second wire CA2 refers to a wire connecting the first wire CA1 and the drive unit. The fourth wire CA4 refers to a wire connecting the third wire CA3 and the drive unit. Note that, in FIGS. 2 and 3, the second wire CA2 and the fourth wire CA4 are omitted to avoid complication of the drawings.

In the second part CN2, a connecting portion CN21 and a connecting portion CN22 are provided. The connecting portion CN21 refers to a connector to which the second wire CA2 is connected. The connecting portion CN22 refers to a connector to which the fourth wire CA4 is connected.

Here, in the example shown in FIG. 2, the connecting portion CN21 is located on the back side of the connecting portion CN11 and not shown. Further, in the example, the connecting portion CN22 is located on the back side of the connecting portion CN12 and not shown.

The first wire CA1 is connected to the connecting portion CN11 and the second wire CA2 is connected to the connecting portion CN21, and thereby, the first wire CA1 is connected to the drive unit of the robot 20 sequentially via the connecting portion CN11, the connecting portion CN21, and the second wire CA2. That is, the robot control apparatus 30 is connected to the drive unit sequentially via the first wire CA1, the connecting portion CN11, the connecting portion CN21, and the second wire CA2, and may supply electric power to the drive unit.

Further, the third wire CA3 is connected to the connecting portion CN12 and the fourth wire CA4 is connected to the connecting portion CN22, and thereby, the third wire CA3 is connected to the drive unit of the robot 20 sequentially via the connecting portion CN12, the connecting portion CN22, and the fourth wire CA4. That is, the robot control apparatus 30 is connected to the drive unit sequentially via the third wire CA3, the connecting portion CN12, the connecting portion CN22, and the fourth wire CA4, and transmits and receives signals between the drive unit and itself.

Note that the connecting portion CN may be another connecting member that can connect the first wire CA1 and the second wire CA2 and can connect the third wire CA3 and the fourth wire CA4 in place of the connector. Or, the connecting portion CN11 may be a connector to which a part of the first wire CA1 (e.g. a part of the above described power line) is connected. In this case, the connecting portion CN12 is a connector to which a part of the second wire CA2 (a wire corresponding to the part of the first wire CA1) is connected. Further, the connecting portion CN21 may be a connector to which a part of the third wire CA3 (e.g. a part of the above described signal line) is connected. In this case, the connecting portion CN22 is a connector to which a part of the fourth wire CA4 (a wire corresponding to the part of the third wire CA3) is connected. The combination of the connecting portion CN11 and the connecting portion CN12 and the combination of the connecting portion CN21 and the connecting portion CN22 are integrally formed as the connecting portion CN in the example, however, the combinations may be separately formed instead. In this case, the connecting portion CN is formed by the combination of the connecting portion CN11 and the connecting portion CN12 and the combination of the connecting portion CN21 and the connecting portion CN22.

In the example shown in FIG. 2, the connecting portion CN fixed to the housing part R is located inside of the housing part R through the opening portion RH formed in the back surface of the base B. Here, the shape of the opening portion RH (i.e., the opening portion RH formed in the housing part R) is nearly the rectangular shape with the respective triangles on the four corners cut off in the rectangular shape as described above. Further, in the example shown in FIG. 3, the connecting portion CN is fixed to the housing part R so that the first part CN1 may be placed inside of the housing part R and the second part CN2 may be placed outside of the housing part R. That is, in the example, the surface to which the connecting portion CN is fixed of the surfaces of the housing part R is the surface on the positive direction side of the X-axis in the robot coordinate system RC of the surfaces of the housing part R. Note that the surface to which the connecting portion CN is fixed of the surfaces of the housing part R may be another surface of the housing part R in place of the surface on the positive direction side. Or, the housing part R may have a configuration to which the connecting portion CN is fixed so that both the first part CN1 and the second part CN2 may be placed inside of the housing part R or both may be placed outside of the housing part R.

Here, as shown in FIGS. 2 and 3, the base B has a lid part CV through which the first wire CA1 and the third wire CA3 are respectively inserted. In FIG. 1, the lid part CV is omitted to avoid complication. The lid part CV covers at least a part of the opening portion RH. As below, as an example, the case where the lid part CV is a plate-like member covering the whole opening portion RH, in which an insertion hole CH1 through which the first wire CA1 is inserted and an insertion hole CH2 through which the third wire CA3 is inserted are formed will be explained. Note that the lid part CV may be a member having another shape in place of the plate-like member with the insertion hole CH1 and the insertion hole CH2 formed therein. The lid part CV is fastened (fixed) to the base B by one or more fastening members (not shown). The fastening members are e.g. screws that can be fastened or loosened by a user using a tool such as a driver. Note that the fastening members may be other fastening members that can fix the lid part CV to the base B by fastening such as screws that can be fastened or loosened by the user with a hand instead.

Here, as shown in FIG. 3, it is desirable that a depth DT of the housing part R is from about 20 to 40 millimeters and, in the example, about 30 millimeters. This is because, if the depth DT is too deep, the user's hand does not reach the depth of the housing part R and, if the depth DT is too shallow, the connecting portion CN interferes with the back surface of the base B and the lid part CV. Here, the depth DT refers to a length along the X-axis direction in the robot coordinate system RC from the lower surface of the lid part CV to the bottom surface of the housing part R when the lid part CV is fastened to the base B. The lower surface of the lid part CV refers to a surface on the housing part R side of the surfaces of the lid part CV in the case. Further, the bottom surface of the housing part R refers to a surface facing the lid part CV of the inner surfaces of the housing part R in the case. Note that the depth DT may be shallower than 20 millimeters unless the connecting portion CN interferes with the back surface of the base B or the lid part CV, and may be deeper than 40 millimeters when the size of the opening portion RH is larger than the user's hand or when the user is allowed to use a tool for connecting the first wire CA1 to the connecting portion CN.

Next, the lid part CV will be explained. When the lid part CV is attached to the base B, the lid part is in contact with the base B. In the example shown in FIGS. 2 and 3, the lid part CV is in surface contact with the base B. The material of the lid part CV is e.g. the same material as the material of the base B. That is, the lid part CV has conductivity like the base B. Note that it is desirable that the material of the lid part CV having conductivity is a material with a contact resistance between the base B having conductivity and itself equal to or less than 0.1Ω. Thereby, the potential of the lid part CV is nearly equal to the potential of the base B. The potential of the base B is the ground potential in this example. That is, in the example, the potential of the lid part CV is nearly the ground potential when the lid part CV is attached to the base B. As below, as an example, the case where the material of the lid part CV is the same material as the material of the base B will be explained. Note that the lid part CV may have a configuration in point contact with the base B.

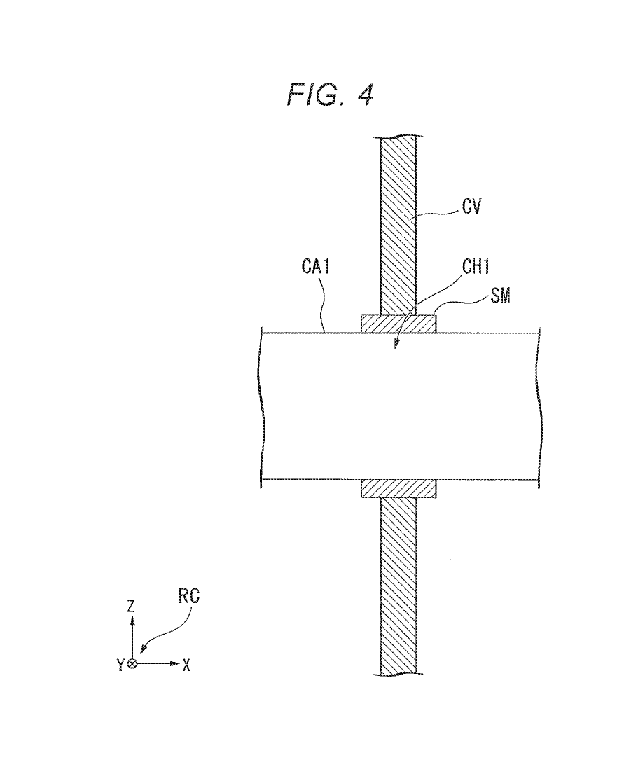

Here, FIG. 4 shows an example of the lid part CV through which the first wire CA1 is inserted. Further, FIG. 4 is a sectional view of the lid part CV through which the first wire CA1 is inserted cut in a plane passing through the center of the insertion hole CH1 formed in the lid part CV and parallel to the ZX-plane in the robot coordinate system RC. Note that the section of the first wire CA1 shown in FIG. 4 is shown in white to avoid complication of the drawing. As shown in FIG. 4, the first wire CA1 is inserted through the insertion hole CH1 formed in the lid part CV and secured by a cable clamp SM. The cable clamp SM is made of a resin, for example. Note that the material of the cable clamp may be another material in place of the resin. The cable clamp SM has a role as a sealing member that seals between the first wire CA1 and the lid part CV (i.e., the insertion hole CH1). In other words, a part of the cable clamp is provided as a sealing member between the first wire CA1 and the lid part CV (i.e., the insertion hole CH1). Note that the first wire CA1 may have a configuration not secured by the cable clamp SM. In this case, the configuration between the first wire CA1 and the lid part CV is a configuration without a sealing member.

Further, in the example, the configuration between the third wire CA3 and the lid part CV (i.e., the insertion hole CH2) is the same configuration as the configuration between the first wire CA1 and the lid part CV, and the explanation is omitted. Note that the third wire CA3 may have a configuration not secured by the cable clamp SM. In this case, the configuration between the third wire CA3 and the lid part CV is a configuration without a sealing member.

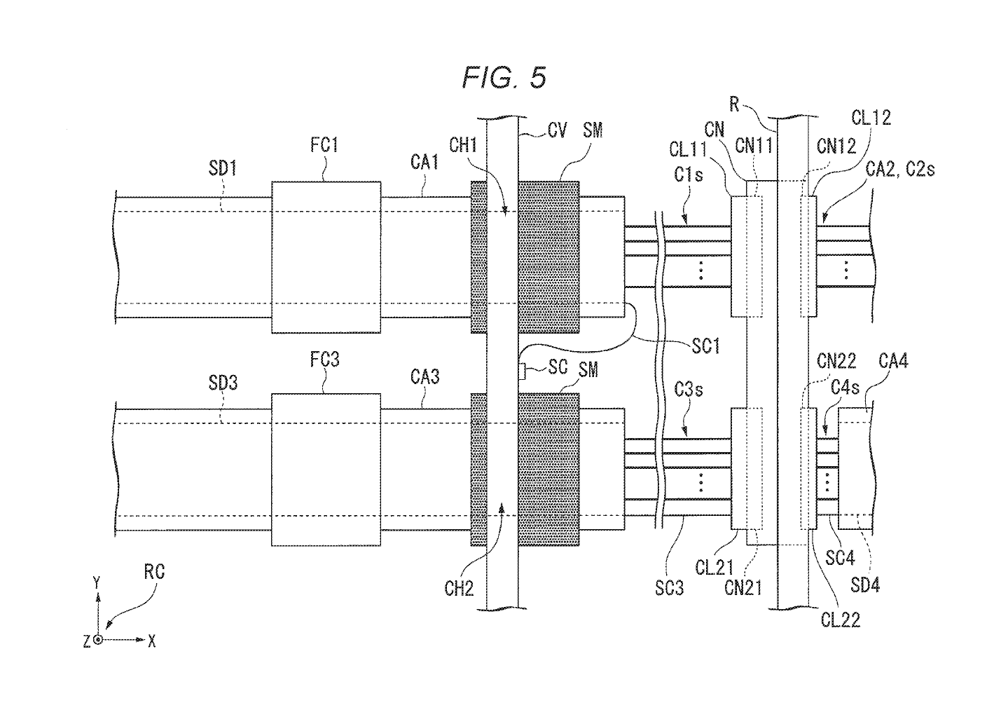

Next, referring to FIG. 5, measures against noise respectively taken for the first wire CA1, the second wire CA2, the third wire CA3, and the fourth wire CA4 will be explained. FIG. 5 shows an example of a connection state of the first wire CA1, the second wire CA2, the third wire CA3, and the fourth wire CA4 via the respective connecting portions CN toward the negative direction of the Z-axis in the robot coordinate system RC. Note that, in FIG. 5, the case of the housing part R without conductivity will be explained as an example.

The first wire CA1 has the power line as described above. In the example shown in FIG. 5, the power line is shown by a plurality of wires C1s. Further, the first wire CA1 has a shield SD1 surrounding the wires C1s in the circumferential direction of the first wire CA1 via an insulator. The shield SD1 refers to a shield that shields electromagnetic wave radiated from the wires C1s when an alternating voltage is applied to the wires C1s.

The coating of the first wire CA1 is removed in the end portion on the robot 20 side. The respective wires C1s without the coating in the end portion are connected to a connecting portion CL11. The connecting portion CL11 is a connector for connecting the wires C1s to the connecting portion CN11. That is, in the example shown in FIG. 5, the wires C1s are connected to the connecting portion CN11 via the connecting portion CL11. A thin wire SC1 is connected to the shield SD1 without the coating in the end portion. In the example, the thin wire SC1 is connected to the lid part CV. As described above, the potential of the lid part CV attached to the base B is nearly the ground potential. That is, the shield SD1 is grounded to the lid part CV. Further, the coating of the first wire CA1 is removed in the end portion on the robot control apparatus 30 side. The shield SD1 is in contact with a part having conductivity of the robot control apparatus 30. That is, the shield SD1 is grounded to the part. The grounding of the shield SD1 to the lid part CV and the part lowers the impedance between the robot control apparatus 30 and the lid part CV. Here, in the example shown in FIG. 5, the thin wire SC1 is fixed to the lid part CV by a screw SC. Note that the thin wire SC1 may have a configuration fixed to the lid part CV by another member in place of the screw SC.

Further, the first wire CA1 has a portion surrounded by a magnetic material FC1 in the circumferential direction. In the example shown in FIG. 5, the portion of the first wire CA1 on the negative direction side of the X-axis in the robot coordinate system of the lid part CV of the portions of the first wire CA1 is surrounded by the magnetic material FC1 in the circumferential direction. The magnetic material FC1 is e.g. a ferrite core. Note that the magnetic material FC1 may be another magnetic material such as FINE MET (registered trademark) in place of the ferrite core. Or, the first wire CA1 may have a configuration without any portion surrounded by the magnetic material FC1 in the circumferential direction.

As shown in FIG. 5, the second wire CA2 includes a plurality of wires C2s connecting the respective wires C1s of the first wire CA1 and the drive unit of the robot 20. The second wire CA2 may have a configuration having an insulator surrounding the wires C2s in the circumferential direction, a shield surrounding the wires C2s via the insulator, and a coating, or a configuration without the insulator surrounding the wires C2s in the circumferential direction, the shield surrounding the wires C2s via the insulator, or the coating. The shield refers to a shield that shields electromagnetic wave radiated from the wires C2s when an alternating voltage is applied to the wires C2s. In the example shown in FIG. 5, the second wire CA2 does not have the insulator surrounding the wires C2s in the circumferential direction, the shield surrounding the wires C2s via the insulator, or the coating. Thereby, the manufacturing cost of the second wire CA2 may be suppressed in the robot 20.

The wires C2s forming the second wire CA2 are connected to the connecting portion CN12 via a connecting portion CL12. The connecting portion CL12 is a connector for connecting the wires C2s to the connecting portion CN12.

The third wire CA3 has the signal line as described above. In the example shown in FIG. 5, the signal line is shown by a plurality of wires C3s. Further, the third wire CA3 has a shield SD3 surrounding the wires C3s in the circumferential direction of the third wire CA3 via an insulator. The shield SD3 refers to a shield that shields electromagnetic wave radiated from the wires C3s when signals are transmitted to the wires C3s.

The coating of the third wire CA3 is removed in the end portion on the robot 20 side. The respective wires C3s without the coating in the end portion are connected to a connecting portion CL21. The connecting portion CL21 is a connector for connecting the wires C3s to the connecting portion CN21. That is, in the example shown in FIG. 5, the wires C3s are connected to the connecting portion CN21 via the connecting portion CL21. A thin wire SC3 is connected to the shield SD3 without the coating in the end portion. In the example, the thin wire SC3 is connected to the connecting portion CL21 with the wires C3s.

Further, the third wire CA3 has a portion surrounded by a magnetic material FC3 in the circumferential direction. In the example shown in FIG. 5, the portion of the third wire CA3 on the negative direction side of the X-axis in the robot coordinate system of the lid part CV of the portions of the third wire CA3 is surrounded by the magnetic material FC3 in the circumferential direction. The magnetic material FC3 is e.g. a ferrite core. Note that the magnetic material FC3 may be another magnetic material such as FINE MET (registered trademark) in place of the ferrite core.

As shown in FIG. 5, the fourth wire CA4 includes a plurality of wires C4s connecting the respective wires C3s of the third wire CA3 and the drive unit of the robot 20. The fourth wire CA4 has a shield SD4 surrounding the wires C4s via an insulator in the circumferential direction. The shield SD4 refers to a shield that shields electromagnetic wave radiated from the wires C4s when signals are transmitted to the wires C4s.

The coating of the fourth wire CA4 is removed in the end portion on the robot 20 side. The respective wires C4s without the coating in the end portion are connected to a connecting portion CL22. The connecting portion CL22 is a connector for connecting the wires C4s to the connecting portion CN22. That is, in the example shown in FIG. 5, the wires C4s are connected to the connecting portion CN22 via the connecting portion CL22. A thin wire SC4 is connected to the shield SD4 without the coating in the end portion. In the example, the thin wire SC4 is connected to the connecting portion CL22 with the wires C4s.

Here, when the connecting portion CL11 is connected to the connecting portion CN11 and the connecting portion CL12 is connected to the connecting portion CN12, the respective wires C1s are connected to the wires C2s corresponding to the wires C1s, respectively. That is, in the case, the first wire CA1 is connected to the second wire CA2 via the connection portion CN. Thereby, the robot control apparatus 30 may supply electric power to the drive unit of the robot 20 via the second wire CA2.

Further, when the connecting portion CL21 is connected to the connecting portion CN21 and the connecting portion CL22 is connected to the connecting portion CN22, the respective wires C3s are connected to the wires C4s corresponding to the wires C3s, respectively. That is, in the case, the third wire CA3 is connected to the fourth wire CA4 via the connecting portion CN. Thereby, the robot control apparatus 30 may transmit and receive signals between the drive unit of the robot 20 and itself via the third wire CA3 and the fourth wire CA4. In the case, the thin wire SC3 is connected to the shield SD4 via the thin wire SC4. Then, the shield SD4 is grounded to the base B (or movable unit A). The grounding of the shield SD4 to the base B lowers the impedance between the robot control apparatus 30 and the base B. The shield SD3 may have a configuration in contact with a part having conductivity of the robot control apparatus 30 or a configuration without contact with the part.

Here, the robot control apparatus 30 supplies a voltage by switching control to the drive unit of the robot 20 via the first wire CA1 and the second wire CA2. As below, as an example, the case where the switching control is PWM (Pulse Width Modulation) control will be explained. Note that the switching control may be other switching control in place of the PWM control. That is, the voltage by PWM control is applied to the first wire CA1 and the second wire CA2 from the robot control apparatus 30.

When the voltage is applied to the first wire CA1 by PWM control, the shield SD1 may radiate electromagnetic wave according to the electromagnetic wave radiated from the respective wires C1s. The radiation of the electromagnetic wave from the shield SD1 (i.e., radiated emission) generates noise in the control of the robot 20 by the robot control apparatus 30. To suppress the noise, in the robot 20, the shield SD1 is grounded to the lid part CV by the thin wire SC1 as described above. Thereby, in the robot 20, the impedance of the thin wire SC1 may be made lower and the impedance of the frame ground between the robot 20 and the robot control apparatus 30 connected via the shield SD1 may be made lower by shortening of the length of the thin wire SC1. As a result, in the robot 20, noise due to electromagnetic wave radiated from the shield SD1 of the first wire CA1 (i.e., radiation noise) may be suppressed. Further, in the robot 20, noise due to the current flowing from the shield SD1 to the lid part CV (i.e., conducted emission) may be suppressed.

The first wire CA1 has the portion surrounded by the magnetic material FC1 in the circumferential direction as described above. Thereby, in the robot 20, the noise due to the electromagnetic wave radiated from the shield SD1 of the first wire CA1 may be suppressed more reliably by the magnetic material FC1. Further, in the robot 20, the noise (i.e., conducted emission) due to the current flowing from the shield SD1 to the lid part CV may be suppressed more reliably.

The robot control apparatus 30 transmits and receives the signals according to operation programs between the drive unit of the robot 20 and itself via the third wire CA3 and the fourth wire CA4. That is, the signals are transmitted to the third wire CA3 and the fourth wire CA4.

When the signal is transmitted to the third wire CA3, the shield SD3 may radiate electromagnetic wave according to the electromagnetic wave radiated from the respective wires C3s. When the signal is transmitted to the fourth wire CA4, the shield SD4 may radiate electromagnetic wave according to the electromagnetic wave radiated from the respective wires C4s. The radiation of electromagnetic wave from the respective shield SD3 and shield SD4 generates noise in the control of the robot 20 by the robot control apparatus 30. To suppress the noise, in the robot 20, the shield SD3 is grounded to the base B via the shield SD4 as described above. Thereby, in the robot 20, the impedance of the frame ground between the robot 20 and the robot control apparatus 30 connected via the shield SD3 and the shield SD4 may be made lower. As a result, in the robot 20, noise due to electromagnetic wave radiated from the shield SD3 of the third wire CA3 (i.e., radiation noise) may be suppressed, and noise due to electromagnetic wave radiated from the shield SD4 of the fourth wire CA4 (i.e., radiation noise) may be suppressed. Further, in the robot 20, noise due to the current flowing from the shield SD3 to the base B (i.e., conducted emission) may be suppressed, and noise due to the current flowing from the shield SD4 to the base B (i.e., conducted emission) may be suppressed.

The third wire CA3 has the portion surrounded by the magnetic material FC3 in the circumferential direction as described above. Thereby, in the robot 20, the noise due to the electromagnetic wave radiated from the shield SD3 of the third wire CA3 may be suppressed more reliably by the magnetic material FC3. Further, in the robot 20, the noise due to the current flowing from the shield SD3 to the base B (i.e., conducted emission) may be suppressed, and noise due to the current flowing from the shield SD4 to the base B (i.e., conducted emission) may be suppressed more reliably.

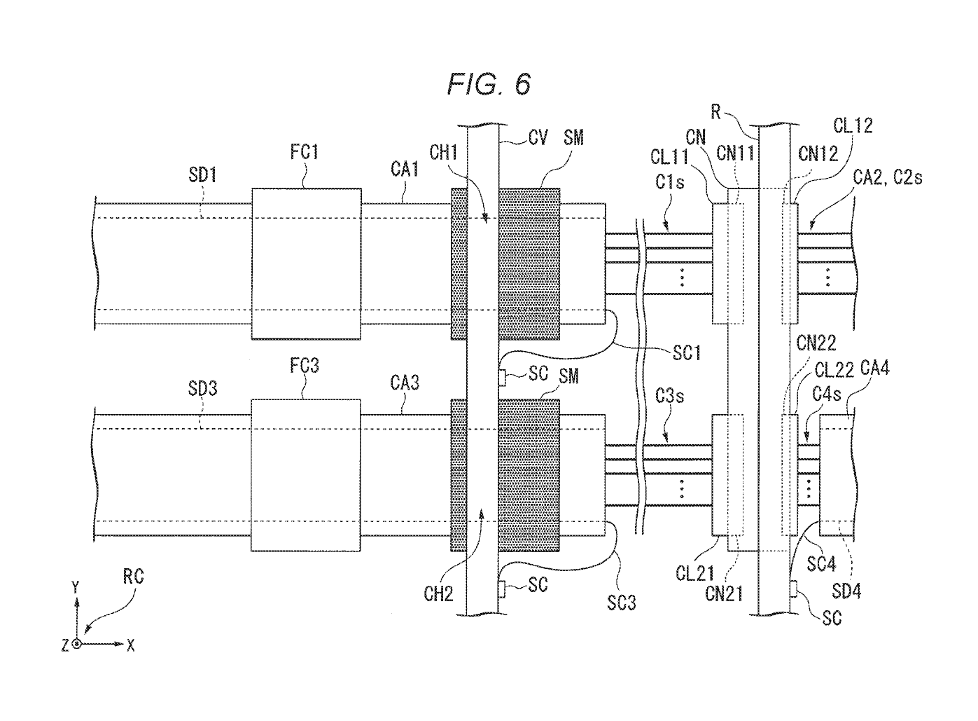

Note that, when the housing part R has conductivity, the measures against noise described in FIG. 5 may be changed to those as shown in FIG. 6. FIG. 6 shows another example of the connection state of the first wire CA1, the second wire CA2, the third wire CA3, and the fourth wire CA4 via the respective connecting portions CN toward the negative direction of the Z-axis in the robot coordinate system RC.

When the housing part R has conductivity, the potential of the housing part R is nearly equal to the potential of the base B because the housing part R is provided in the base B. That is, the material of the housing part R is a material with a contact resistance between the base B having conductivity and itself equal to or less than 0.1Ω. In the case, the thin wire SC3 of the shield SD3 shown in FIG. 5 may be grounded to the lid part CV by a screw SC as shown in FIG. 6. Further, in the case, the thin wire SC4 of the shield SD4 shown in FIG. 5 may be grounded to the housing part R by a screw SC as shown in FIG. 6. Thereby, in the robot 20, the noise due to the electromagnetic wave radiated from the shield SD3 of the third wire CA3 (i.e., radiation noise) may be further suppressed than that in the case where the shield SD3 is grounded to the base B via the shield SD4. In the robot 20, the noise due to the electromagnetic wave radiated from the shield SD4 of the fourth wire CA4 (i.e., radiation noise) may be further suppressed than that in the case where the shield SD4 is grounded to the base B. Note that the material of the housing part R may be a material different from the material of the lid part CV or the same material as the material of the lid part CV.

When the housing part R has conductivity and the second wire CA2 has the shield, the shield may be grounded to the housing part R by a thin wire. Thereby, in the robot 20, the noise due to the electromagnetic wave radiated from the second wire CA2 (i.e., radiation noise) may be suppressed.

Note that the housing part R may have conductivity wholly or partially. When a part of the housing part R has conductivity, the shield of the second wire CA2 is grounded to the part.

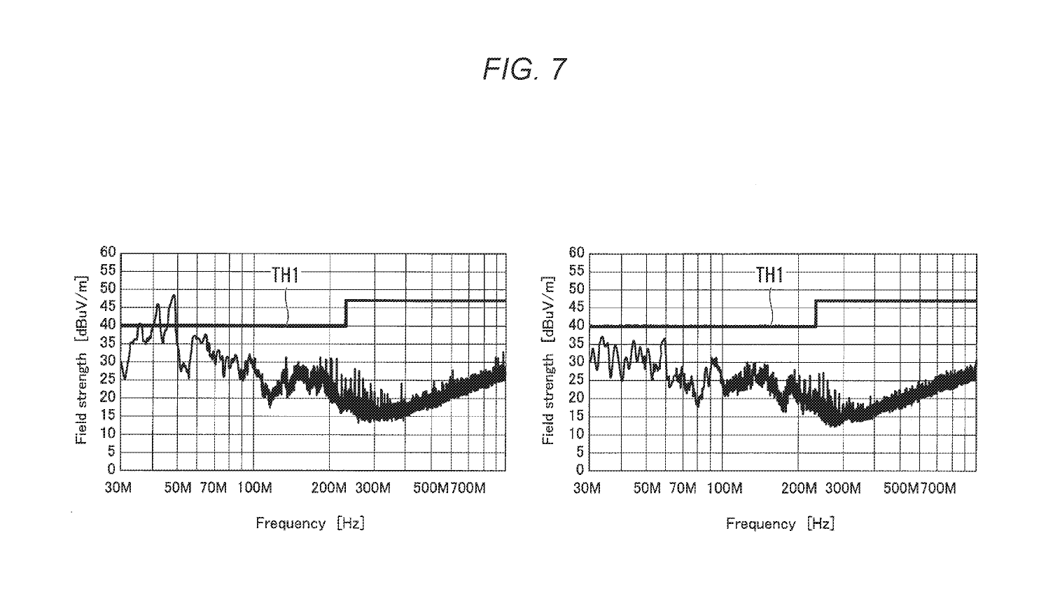

Next, referring to FIG. 7, noise due to radiated emission in the respective cases with or without the measures against noise described in FIG. 5 is compared. Specifically, the measures against noise are grounding of the shield SD1 to the lid part CV, attachment of the magnetic material FC1 to the first wire CA1, and attachment of the magnetic material FC3 to the third wire CA3. FIG. 7 shows graphs for comparison of noise due to radiated emission in the respective cases with and without the measures against noise described in FIG. 5. The horizontal axes of the respective right and left graphs shown in FIG. 7 indicate frequencies. The vertical axes of the graphs indicate magnitude of noise of the frequencies shown by the horizontal axes of the graphs. Further, lines TH1 shown in the graphs indicate upper limit values of the allowable magnitude of noise at the frequencies indicated by the horizontal axes.

Here, the left graph in FIG. 7 shows an example of the magnitude of the noise due to radiated emission without the measures against noise described in FIG. 5. As shown by the graph, in the frequency band less than 50 MHz, the magnitude of the noise due to radiated emission exceeds the upper limit values shown by the line TH1. On the other hand, the right graph in FIG. 7 shows an example of the magnitude of the noise due to radiated emission with the measures against noise described in FIG. 5. As shown by the graph, in the frequency band less than 50 MHz, the magnitude of the noise due to radiated emission does not exceed the upper limit values shown by the line TH1. This shows that, in the robot 20, the noise due to radiated emission may be suppressed by the measures against noise described in FIG. 5.

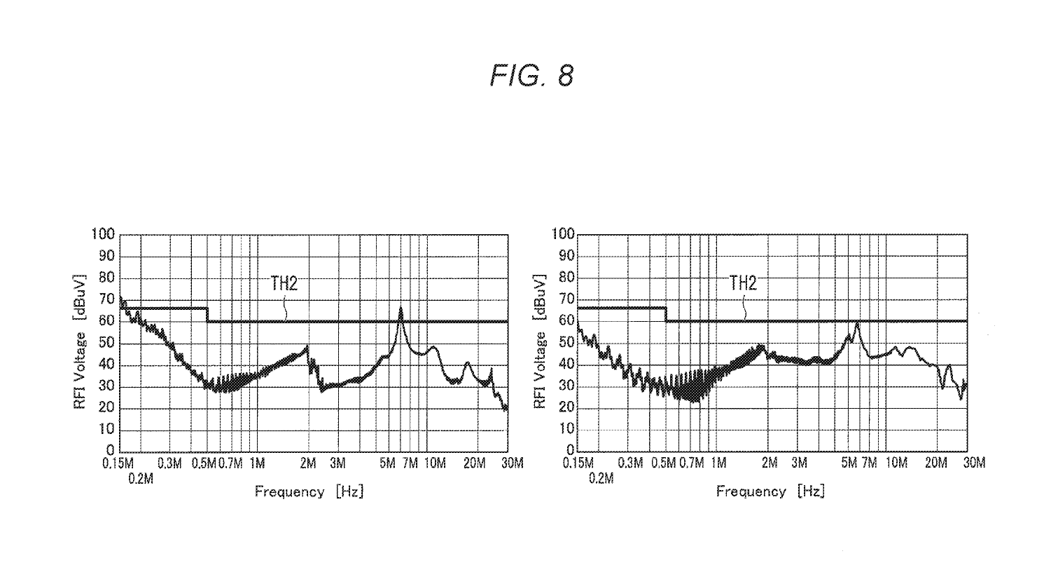

Next, referring to FIG. 8, the magnitude of the conducted emission in the respective cases with or without the measures against noise described in FIG. 5 is compared. FIG. 8 shows graphs for comparison of magnitude of conducted emission in the respective cases with or without measures against noise described in FIG. 5. The horizontal axes of the respective right and left graphs shown in FIG. 8 indicate frequencies. The vertical axes of the graphs indicate noise of the frequencies shown by the horizontal axes of the graphs, i.e., magnitude of the conducted emission. Further, lines TH2 shown in the graphs indicate upper limit values of the allowable magnitude of conducted emission at the frequencies indicated by the horizontal axes.

Here, the left graph in FIG. 8 shows an example of the magnitude of the conducted emission in the case without the measures against noise described in FIG. 5. As shown by the graph, in the frequency band around 7 MHz, the magnitude of the conducted emission exceeds the upper limit values shown by the line TH2. On the other hand, the right graph in FIG. 8 shows an example of the magnitude of the conducted emission with the measures against noise described in FIG. 5. As shown by the graph, in the frequency band around 7 MHz, the magnitude of the conducted emission does not exceed the upper limit values shown by the line TH2. This shows that, in the robot 20, the conducted emission may be suppressed by the measures against noise described in FIG. 5.

Returning to FIGS. 2 and 3, the first part CN1 of the connecting portion CN, the first wire CA1, and the third wire CA3 are housed inside of the housing part R. Accordingly, processing for suppressing entry of foreign matter such as waterproofing is not necessary between the first part CN1 and the first wire CA1 and third wire CA3. As a result, a manufacturer of the robot 20 may manufacture the robot 20 using an inexpensive connector as the connecting portion CN and may manufacture the robot 20 using inexpensive wires as one or both of the first wire CA1 and the third wire CA3. That is, the robot 20 may suppress monetary cost increase related to the manufacture of the robot 20.

Note that, in the case where the connecting portion CN fixed to the housing part R includes a plurality of connectors, part or all of the plurality of connectors may have different shapes from one another or have the same shape with one another. When all of the plurality of connectors have different shapes from one another, the robot 20 may suppress misconnection of wires by the user.

The connecting portion CN is fixed to the housing part R, and thus, the connecting portion CN is not taken from inside of the base B to outside of the base B when work of respectively detaching the first wire CA1 and the third wire CA3 from the connecting portion CN is performed. Accordingly, regarding the respective second wire CA2 and fourth wire CA4 connected to the second part CN2 of the connecting portion CN outside of the housing part R inside of the base B, the extra lengths for the connecting portion CN to be taken from inside of the base B to outside of the base B may be made shorter. As a result, the robot 20 may suppress generation of noise in the respective second wire CA2 and fourth wire CA4.

Returning to FIG. 1, the above described drive unit of the robot 20 drives the movable unit A. In the example, the drive unit refers to each of a first drive unit M1, a second drive unit M2, a third drive unit M3, and a fourth drive unit M4. Note that the drive unit may include another drive unit in place of part or all of these four drive units, or may include another drive unit in addition to all of the four drive units.

The first drive unit M1 is the drive unit that rotates the first arm A1 about the first axis AX1 relative to the base B, and provided inside of the base B. The first drive unit M1 is an actuator controlled by the robot control apparatus 30. That is, the first axis AX1 is an axis that coincides with the rotation shaft of the first drive unit M1.

The first arm A1 rotates about the first axis AX1 and moves in horizontal directions with the rotation of the rotation shaft of the first drive unit M1. The horizontal directions are directions orthogonal to the upward and downward directions in the example. That is, in the example, the horizontal directions are directions along the XY-plane in the robot coordinate system RC of the robot 20.

The second drive unit M2 is the drive unit that rotates the second arm A2 about the second axis AX2 relative to the first arm A1, and provided inside of the second arm A2. The second drive unit M2 is an actuator controlled by the robot control apparatus 30. That is, the second axis AX2 is an axis that coincides with the rotation shaft of the second drive unit M2.

The second arm A2 rotates about the second axis AX2 and moves in the horizontal directions with the rotation of the rotation shaft of the second drive unit M2.

The third drive unit M3 is the drive unit that moves the shaft S in the upward and downward directions by turning the ball screw nut provided in the outer circumference part of the ball screw groove of the shaft S with a timing belt (not shown) or the like, and provided inside of the second arm A2. The third drive unit M3 is a vertical actuator controlled by the robot control apparatus 30.

The fourth drive unit M4 rotates the shaft S about the center axis of the shaft S by turning the ball spline nut provided in the outer circumference part of the spline groove of the shaft S with a timing belt (not shown) or the like, and provided inside of the second arm A2. The fourth drive unit M4 is a rotation actuator controlled by the robot control apparatus 30.

The respective first drive unit M1 to fourth drive unit M4 as the four drive units of the robot 20 are supplied with electric power from the robot control apparatus 30 by the first wire CA1 and the second wire CA2. Further, the respective first drive unit M1 to fourth drive unit M4 transmit and receive signals between the robot control apparatus 30 and themselves by the third wire CA3 and the fourth wire CA4. Note that the wired communications via the third wire CA3 and the fourth wire CA4 are performed according to standards of e.g. Ethernet (registered trademark), USB (Universal Serial Bus), or the like. Or, part of the four drive units may have configurations connected to the robot control apparatus 30 via wireless communications performed according to communication standards of Wi-Fi (registered trademark) or the like in place of the configurations connected to the robot control apparatus 30 by the third wire CA3 and the fourth wire CA4.

The robot control apparatus 30 operates the robot 20 by supplying the electric power to the robot 20 by the first wire CA1 and the second wire CA2 and transmitting the control signals to the robot 20 by the third wire CA3 and the fourth wire CA4. Thereby, the robot control apparatus 30 may allow the robot 20 to perform predetermined work. The robot control apparatus 30 is separately provided from the robot 20 and placed outside of the robot 20.

As described above, the robot 20 in the embodiment is a robot controlled by a robot control apparatus (the robot control apparatus 30 in the example), and includes a base having conductivity (the base B in the example), a movable unit (the movable unit A in the example) provided on the base, a drive unit (each of the first drive unit M1 to fourth drive unit M4 in the example) that drives the movable unit, a connecting portion (the connecting portion CN in the example) connected to the robot control apparatus 30 by a first wire having a power line (the first wire CA1 in the example), and a second wire (the second wire CA2 in the example) that connects the drive unit and the connecting portion, and the base has a housing part (the housing part R in the example) having an opening portion (the opening portion RH in the example), to which the connecting portion is fixed and a lid part (the lid part CV in the example) covering at least apart of the opening portion, through which the first wire is inserted, the first wire has a shield (the shield SD1 in the example) in contact with the lid part, and the shield is in contact with a part having conductivity of the robot control apparatus. Thereby, in the robot 20, a defect in at least one of the connecting portion and the second wire may be suppressed and noise due to electromagnetic wave radiated from the first wire may be suppressed.

In the robot 20, the potential of the lid part is equal to the potential of the base. Thereby, in the robot 20, the noise due to electromagnetic wave radiated from the first wire may be suppressed more reliably by the lid part having the equal potential to the potential of the base.

In the robot 20, a voltage by switching control (PWM control in the example) is applied to the first wire. Thereby, in the robot 20, the noise due to electromagnetic wave radiated from the first wire to which the voltage by switching control is applied may be suppressed.

In the robot 20, the lid part and the base are in contact. Thereby, in the robot 20, the noise due to electromagnetic wave radiated from the first wire may be suppressed more reliably by the lid part in contact with the base.

In the robot 20, the lid part and the base are in surface contact. Thereby, in the robot 20, the noise due to electromagnetic wave radiated from the first wire may be suppressed more reliably by the lid part in surface contact with the base.

In the robot 20, the connecting portion has a first connecting portion (the connecting portion CN11 in the example) to which the first wire is connected and a second connecting portion (the connecting portion CN21 in the example) to which the third wire (the third wire CA3 in the example) having the signal line is connected. Thereby, in the robot 20, the noise due to electromagnetic wave radiated from the first wire connected to the first connecting portion may be suppressed.

In the robot 20, the third wire has a shield (the shield SD3 in the example) and has a portion surrounded by a magnetic material (the magnetic material FC3 in the example) in the circumferential direction. Thereby, in the robot 20, the noise due to electromagnetic wave radiated from the first wire connected to the first connecting portion may be suppressed, and the noise due to electromagnetic wave radiated from the third wire connected to the second connecting portion may be suppressed.

In the robot 20, the first wire has a portion surrounded by a magnetic material (the magnetic material FC1 in the example) in the circumferential direction. Thereby, in the robot 20, the noise due to electromagnetic wave radiated from the first wire may be suppressed more reliably by the magnetic material.

In the robot 20, a resin (the cable clamp SM in the example) is provided between the first wire and the lid part. Thereby, in the robot 20, entry of foreign matter from between the first wire and the lid part into the housing part may be suppressed.

In the robot 20, the housing part has no conductivity. Thereby, in the robot 20, the noise due to electromagnetic wave radiated from the first wire may be suppressed by the lid part covering the opening portion of the housing part without conductivity.

In the robot 20, the housing part has conductivity. Thereby, in the robot 20, the noise due to electromagnetic wave radiated from the first wire may be suppressed by the lid part covering the opening portion of the housing part with conductivity.

In the robot 20, the second wire has a shield in contact with the housing part. Thereby, in the robot 20, the noise due to electromagnetic wave radiated from the first wire may be suppressed, and the noise due to electromagnetic wave radiated from the second wire may be suppressed.

The robot 20 includes the fourth wire (the fourth wire CA4 in the example) connecting the drive unit and the connecting portion and the fourth wire has a shield (shield SD4 in the example) in contact with the housing part. Thereby, in the robot 20, the noise due to electromagnetic wave radiated from the first wire may be suppressed, and the noise due to electromagnetic wave radiated from the fourth wire may be suppressed.

As above, the embodiments of the invention are described with reference to the drawings, however, the specific configurations are not limited to the embodiments and changes, replacements, deletions, etc. may be made without departing from the scope of the invention.

The entire disclosure of Japanese Patent Application No. 2017-189064, filed Sep. 28, 2017 is expressly incorporated by reference herein.

What is claimed is:

1. A robot controlled by a robot control apparatus comprising:
a base having conductivity;
an arm provided on the base;
an actuator that drives the arm;
a connector connected to the robot control apparatus by a first wire having a power line; and
a second wire that connects the actuator and the connector, wherein
the base has
a housing part having an opening portion, to which the connector is fixed, and
a lid part covering at least a part of the opening portion, through which the first wire is inserted,
the first wire has a shield in contact with the lid part, and
the shield is in contact with a part having conductivity of the robot control apparatus.

2. The robot according to claim 1, wherein a potential of the lid part is equal to a potential of the base.

3. The robot according to claim 1, wherein a voltage by switching control is applied to the first wire.

4. The robot according to claim 1, wherein the lid part and the base are in contact with each other.

5. The robot according to claim 4, wherein the lid part and the base are in surface contact with each other.

6. The robot according to claim 1, wherein the connector has a first connector to which the first wire is connected and a second connector to which a third wire having a signal line is connected.

7. The robot according to claim 6, wherein the third wire has a shield and has a portion surrounded by a magnetic material in a circumferential direction.

8. The robot according to claim 1, wherein the first wire has a portion surrounded by a magnetic material in a circumferential direction.

9. The robot according to claim 1, wherein a resin is provided between the first wire and the lid part.

10. The robot according to claim 1, wherein the housing part has no conductivity.

11. The robot according to claim 1, wherein the housing part has conductivity.

12. The robot according to claim 11, wherein the second wire has a shield in contact with the housing part.

13. The robot according to claim 11, further comprising a fourth wire that connects the actuator and the connector,
wherein the fourth wire has a shield in contact with the housing part.

14. A robot system comprising:
the robot; and
the robot control apparatus that controls the robot, wherein
the robot includes a base having conductivity, an arm provided on the base, an actuator that drives the arm, a connector connected to the robot control apparatus by a first wire having a power line, and a second wire that connects the actuator and the connector,
the base has a housing part having an opening portion, to which the connector is fixed, and a lid part covering at least a part of the opening portion, through which the first wire is inserted,
the first wire has a shield in contact with the lid part, and
the shield is in contact with a part having conductivity of the robot control apparatus.

15. The robot system according to claim 14, wherein a potential of the lid part is equal to a potential of the base.

16. The robot system according to claim 14, wherein a voltage by switching control is applied to the first wire.

17. The robot system according to claim 14, wherein the lid part and the base are in contact with each other.

18. The robot system according to claim 17, wherein the lid part and the base are in surface contact with each other.

19. The robot system according to claim 14, wherein the connector has a first connector to which the first wire is connected and a second connector to which a third wire having a signal line is connected.

20. The robot system according to claim 19, wherein the third wire has a shield and has a portion surrounded by a magnetic material in a circumferential direction.
